(19) United States
(12) Patent Application Publication
(10) Pub. No.: US 2009/0177649 A1
(43) Pub. Date: Jul. 9, 2009

(54) Answer Search System and Method

(75) Inventor: Yen-Wu Hsieh, Hsin-Chu (TW)

Correspondence Address: SQUIRE, SANDERS & DEMPSEY L.L.P., 1 MARITIME PLAZA, SUITE 300, SAN FRANCISCO, CA, 94111, US

(73) Assignee: Yen-Wu Hsieh, Hsin-Chu (TW)

(21) Appl. No.: 12/267,490

(22) Filed: Nov. 7, 2008

(30) Foreign Application Priority Data
Jan. 4, 2008 (TW) 097100294

(51) Int. Cl. G06F 7/06; G06F 17/30

(52) U.S. Cl. 707/5; 707/3; 707/E17.014

(57) ABSTRACT

An answer searching system and method is disclosed herein. The answer searching system includes a user, a database, a few of experts and a service platform. The user sends at least one question by a communication device. The database stores a number of experts' data. The experts are corresponding to the experts' data stored in the database. The service platform is used to receive the questions sent from the user and search a suitable expert's data in accordance with the question in the database. Therefore, the service platform contacts the expert to answer the question and send the expert's answer back to the user. The user gives a feedback to the expert and save the feedback in the expert's data of the database.

### BACKGROUND OF THE INVENTION

1. Field of the Invention

The present invention is related to an answer search system and method, and more particularly to an answer search system by using a communicative device.

2. Description of the Prior Art

People always have some questions in daily life. They would like to find the answers, but don't know where to find. For example, how to cook fried rice, how to solve the virus problem in my computer or how to write a love to someone, those questions may be not so difficult or complicated. However, when the people would like find the answers immediately, there is no one able to help them and they have no idea where to find the answer.

Although internet is so popular all around the earth, those questions can be found by using the online search engine or digging in the forum web sites. Those methods to find the answers are wasting time because the people need to search one by one to find the best answers and the answers may be not good enough. Besides, the internet service is not available anytime and anywhere, and there are some people don't know how to use computer and how to browse the web site on the internet.

Therefore, according to the problems described above, there is a need existed to design a service platform for everyone and the service platform is able to help people to solve all the questions they want.

### SUMMARY OF THE INVENTION

According to the background of the present invention, the object of the present invention is to provide an answer search system. The answer search system can help the user to find the answer by using a mobile phone or a regular phone.

Another object of the present invention is to provide an answer search method for the user to find the answer what he wants as soon as possible without surfing over the internet.

An answer search system includes a user, a database, a plurality of experts, and a service platform. The user is transmitting at least one question by an electronic device. The database is stored a plurality of experts' data. The experts are corresponding to the experts' data stored in the database. The service platform is able to receive the question transmitted by the user, search one of the experts' data in said database according to the question; contact the expert, who is corresponding to the expert's data, to solve said question; transmit an answer provided by the expert to the user; and store a rating provided by said user in the database according to the answer.

An answer search method includes the following steps: transmitting at least one question from a user; receiving and analyzing a first knowledge field of said question; comparing said first knowledge field and a plurality of second knowledge fields in a database; transmitting said question to an expert corresponding to said second knowledge field; answering said question and transmitting an answer to said service platform by said expert; transmitting said answer to said user by said service platform; transmitting a rating back to said service platform by said user; and storing said rating in said database where said expert's data is stored.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a block diagram illustrating an answer search system by utilizing a communicative device.

FIG. 2 is a view illustrating the answer search system of the present invention.

FIG. 3 is a flowchart illustrating the answer search method of the present invention.

FIG. 4 is a flowchart illustrating the answer search method according another embodiment of the present invention.

### DESCRIPTION OF THE PREFERRED EMBODIMENT

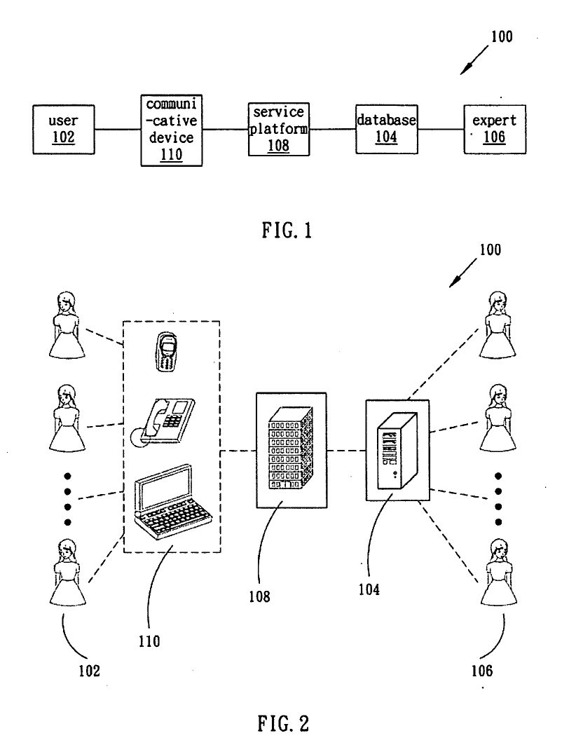

FIG. 1 is a block diagram showing an answer search system by utilizing a communicative device. As shown in FIG. 1, the answer search system includes a user 102, a database 104, an expert 106 and a service platform 108. The user 102 transmits a question by a communicative device 110 and the communicative device can be a mobile phone, a regular phone or a VOIP (voice over internet protocol) phone. Any communicative devices 110 are able to transmit the question by voice, message, email, or browser can be utilized in the answer search system of the present invention. The database 104 is used to store the basic information of the expert 106. The basic information of the expert 106 includes knowledge field, contact period, contact method and rating. The knowledge field is the field what kind f questions the expert 106 can solve. The contact period is the working hours when the expert 106 is available (when the expert 106 can solve the question). The contact method is the expert's home phone number, mobile phone number, email address and so on. The rating is used to determine the ability of the expert 106 and is provide by the question of the user 102. The service platform 108 is used to receive the question provided by the user 102. The service platform 108 will search the database 104 to find a suitable expert data according to the question. The service platform 108 will find and contact the expert 106 corresponding to the expert data found in the database. The expert 106 will answer the question provided by the user 102 and send it back to the service platform 108. The service platform 108 will transmit the answer to the user 102. The user 102 will give a rating to the expert 106 according to the answer to show whether the user 102 is satisfied the answer or not. The service platform 108 will store the rating to the expert data corresponding to the expert 106 in the database.

FIG. 2 is a view showing the answer search system of the present invention. As shown in FIG. 2, there is more than one user 102 using the answer search system. There are several service staffs working in the service platform 108 to listen the questions from the users 102, and the staffs will search the database and find the expert to answer the questions. In a different embodiment, the service platform 108 can include an interactive voice response system. The user 102 uses the key pads of the communicative device 110 to transmit the question to the service platform 108. The interactive voice response system of the service platform 108 will transform the question to digital data and transmit the question to the database 104. The database 104 will search for a suitable expert data according to the key words of the question and contact the expert 106 to answer the question. In one another embodiment, the service platform 108 includes a voice recognition system. The voice system of the service platform 108 will transform the voice question to digital data and transmit to the database 104. The database 104 will search for a suitable expert data therein and contact the expert 106 corresponding to the expert data. Besides, the rating is a kind of tool to determine the ability and satisfaction of the expert. When the database 104 is searching for a suitable expert data and finding there is more than one expert able to solve the question. The database 104 will check the rating in the expert data to find an expert with higher rating to answer the question.

Still referring to FIG. 2, in a different embodiment of the present invention, the user 102 will connect to the device with internet (such as desktop, laptop, personal digital assistant (PDA), smart phone and so on) to fill out the question on the web site or write an email with the question and transmit the question to the service platform 108. In the embodiment, the service platform 108 is a server. The server is able to figure out the key words of the question and search a suitable expert 106 according to the key words. When the server found the expert 106, the server will transmit the question to the expert 106. The expert 106 will answer the question and send the answer back to the server (the service platform 108). The service platform 108 will transmit the answer to the user 102. As the embodiment described above, the user 102 will also give the expert 106 a rating according to the answer. The service platform 108 will store the rating in the database where the expert data located. Besides, if the user 102 is asking about the question regarding a specific product, the manufacture of the product can be the expert 106 in this embodiment.

In addition, the communication device 110 used in the present invention is a mobile phone, a regular phone, a network phone or any other portable device able to transmit voice, message or email. The mobile phone can transmit the question by voice, key pads, word message, email, and so on. The regular phone can transmit the question by voice, key pads and so on. The network phone is a phone such as skype phone or a voice over internet protocol (VOIP) phone by using internet protocol to transmit the voice and the function of the network phone is the same as the regular phone able to transmit the question by voice, key pads or message. But the different between the network phone and the regular phone is that the telephone transmitter in the network phone is not a necessary requirement. The network phone can use the portable device (such as PDA or notebook) to transmit the question by the microphone and the speaker.

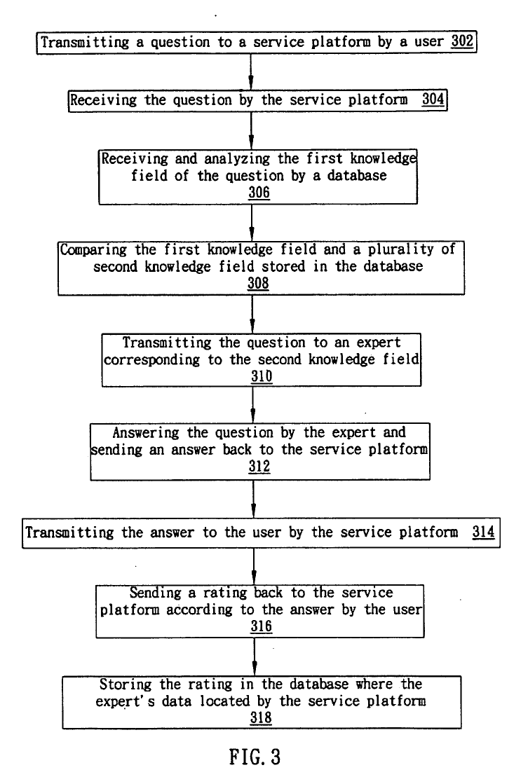

FIG. 3 is a flowchart showing the answer search method of the present invention. As shown in FIG. 3, the answer search method of the present invention includes the following steps. In step 302, the user will transmit the question to the service platform by voice, key pads, message, email, and so on. In this embodiment, the user is transmitting the question by voice. In step 304, the service platform will receive the question. In step 306, when the service platform is receiving the question, there are service staffs or a voice recognition system to receive the question provided by the user, it is not limited in the present invention. In step 308, the database will figure out the knowledge field (also called the first knowledge filed) of the question. In step 310, the database will compare the first knowledge field and the second knowledge fields stored in the database and find a suitable second knowledge field. In step 312, the question will send to the expert corresponding to the second knowledge field. The expert will answer the question and send the answer back to the service platform. In step 314, the service platform will send the answer to the user. In step 316, the user will give the expert a rating according to the answer. At final, in step 318, the service platform will store the rating in the database where the expert's data located. Therefore, the steps of the answer search method are completed.

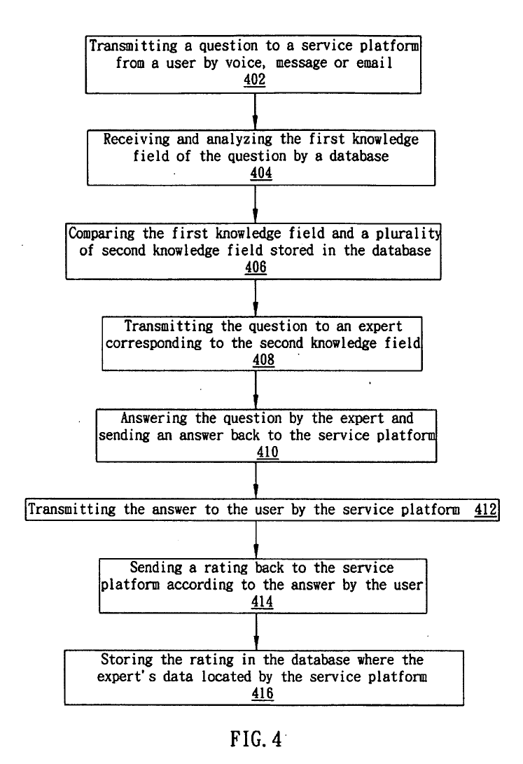

FIG. 4 is a flowchart showing the answer search method according another embodiment of the present invention. As shown in FIG. 4, the answer search method of the present invention includes the following steps. In step 402, the user will transmit the question to the service platform by key pads, message, and email. In step 404, the database will receive the question and analyze the knowledge field (also called the first knowledge field) of the question. In step 406, the database will compare the first knowledge field and the second knowledge fields stored in the database and find a second knowledge matched the first knowledge field. In step 408, the question will transmit to the expert corresponding to the second knowledge field and the expert will answer the question and send the answer back to the service platform. In step 410, the service platform will transmit the answer to the user. In step 412, the user will give a rating to the expert and send it back to the service platform. At final, in step 414, the service platform will store the rating in the database where the expert's data located. Therefore, the steps of the answer search method in this embodiment are completed.

What is claimed is:

1. An answer search system comprising:
an user transmitting at least one question by an electronic device;
a database stored a plurality of experts' data;
a plurality of experts corresponding to said experts' data stored in said database; and
a service platform comprising:
receiving said question transmitted by said user;
searching one of said experts' data in said database according to said question;
contacting said expert, who is corresponding to said experts' data, to solve said question;
transmitting an answer provided by said expert to said user; and
storing a rating provided by said user in said database according to said answer form said expert.

2. The answer search system of claim 1, wherein said electronic device is mobile device, home phone, VOIP, portable device and computer.

3. The answer search system of claim 1, wherein said user transmits said question by voice, message, email and browser.

4. The answer search system of claim 1, wherein said rating is stored in said expert's data of said database.

5. The answer search system of claim 4, wherein said rating is used to determine the ability of said expert, and said expert with said high rating has high priority to be chosen to solve said question.

6. The answer search system of claim 5, wherein said experts' data further includes at least one knowledge field and at least one contact period.

7. The answer search system of claim 6, wherein said platform is searching one of said suitable expert by comparing said question provided by said user and said knowledge field of said expert data.

8. The answer search system of claim 1, wherein said answer search system further includes at least one service staff to operate said service platform.

9. The answer search system of claim 1, wherein said answer search system further includes an interactive voice response system to operate said service platform.

10. The answer search system of claim 1, wherein said answer search system further includes a voice recognition system to operate said service platform.

11. An answer search method comprising:
transmitting at least one question from an user;
receiving and analyzing a first knowledge field of said question;
comparing said first knowledge field and a plurality of second knowledge fields in a database;
transmitting said question to an expert corresponding to said second knowledge field;
answering said question and transmitting an answer to said service platform by said expert;
transmitting said answer to said user by said service platform;
transmitting a rating back to said service platform by said user; and
storing said rating in said database where said expert's data is stored.

12. The answer search method of claim 11, wherein said user transmits said question by an electronic device and said electronic device is mobile phone, regular phone, VOIP, and computer.

13. The answer search method of claim 11, wherein said user transmits said question by voice, message, email and browser.

14. The answer search method of claim 11, wherein said question is received by at least one service staff, when said answer search method is transmitting at least one question by said user to said service platform.

15. The answer search method of claim 11, wherein said question transmitted by said user is received and analyzed by a server.

16. The answer search method of claim 15 further comprising analyzing a plurality of key words of said question by said server and searching said suitable expert according to said key words of said question.

17. The answer search method of claim 15, wherein said server includes an interactive voice response system to receive said question of said user when said step is transmitting said question to said service platform by said user.

18. The answer search method of claim 17, wherein said user uses a key pads system of said electronic device to transmit said question to said interactive voice response system.

19. The answer search method of claim 15, wherein said server includes a voice recognition system to receive said question of said user when said method is transmitting said question to said service platform by said user.

20. The answer search method of claim 11, wherein said expert with said higher rating has higher priority to be chosen, when said method is comparing said first knowledge field and said second knowledge fields in said database.
